(19) United States
(12) Patent Application Publication
(10) Pub. No.: US 2014/0003025 A1
(43) Pub. Date: Jan. 2, 2014

(54) PHOTOGRAPHIC DEVICE

(71) Applicant: VIVOTEK INC., New Taipei City (TW)

(72) Inventors: Shyh-Yih MA, New Taipei City (TW); Chung-Yon HUANG, New Taipei City (TW)

(73) Assignee: VIVOTEK INC., New Taipei City (TW)

(21) Appl. No.: 13/834,854

(22) Filed: Mar. 15, 2013

(30) Foreign Application Priority Data
Jun. 27, 2012 (TW) 101123094

(51) Int. Cl. G03B 15/02

(52) U.S. Cl. CPC G03B 15/02
USPC 362/11; 362/3; 362/16

(57) ABSTRACT

A photographic device includes a casing, a photographic body, an auxiliary light source and an adjusting assembly. The casing includes an opening. The photographic body, disposed in the casing, and the photographic body, corresponds to the opening. The photographic body is adapted for image capturing. The auxiliary light source, disposed between the casing and the photographic body, is adapted for emitting light outside through the opening. The adjusting assembly, disposed in the casing, is connected to the auxiliary light source. The adjusting assembly is adapted for driving the auxiliary light source to move relative to the opening.

### CROSS-REFERENCE TO RELATED APPLICATIONS

This non-provisional application claims priority under 35 U.S.C. §119(a) on Patent Application No(s). 101123094 filed in Taiwan, R.O.C. on Jun. 27, 2012, the entire contents of which are hereby incorporated by reference.

### TECHNICAL FIELD

The disclosure relates to a photographic device, and more particularly to a photographic device including an adjustable auxiliary light source.

### BACKGROUND

Recently, surveillance cameras are widely used in a security monitoring system. In other words, no matter at homes, enterprises, governments or public places, the surveillance cameras become necessary monitoring tools for human security and asset protection. Typically, the surveillance cameras may keep watch for the condition of a monitored environment such that any occurrence of instant and special event may be detected immediately. Therefore, when a special event happens, users may detect the occurrence by the surveillance camera, or the surveillance cameras may inform the user automatically such that the user may handle the event instantly.

In a prior art device, in order to clearly detect the condition of the monitored environment, the surveillance camera comprises a zoom lens module. The user may control the focus of the lens module remotely, and the user may zoom in or zoom out an image captured by the lens module. Therefore, the user may clearly detect and monitor a certain object in the monitored environment.

Moreover, an auxiliary light source is further provided in the surveillance cameras. In a dark environment (i.e., with low illumination), the auxiliary light source may emit light which illuminates the monitored environment, region or object observed by the surveillance cameras. In other words, the auxiliary light source may provide the light with appropriate illumination and illuminating region, such that the surveillance camera may capture better images. Furthermore, the user may adjust the illuminating region of the auxiliary light source manually so as to conform to the actual requirement of the monitored environment.

However, in the prior art surveillance cameras, when the illuminating region of the auxiliary light source needs to be changed, the user must adjust the illuminating region of the auxiliary light source manually. This manual adjustment approach is uneasy to adjust the camera. In addition, when the monitored region of the surveillance camera needs to be changed, the auxiliary light source may not be adjusted automatically and accordingly, which makes low illumination of the monitored region, such that the surveillance cameras may not obtain clear image. Therefore, the surveillance cameras may not acquire better imaging effect.

### SUMMARY

An embodiment of the disclosure provides a photographic device comprising a casing, a photographic body, an auxiliary light source and an adjusting assembly. The casing includes an opening. The photographic body, disposed in the casing, and the photographic body, corresponds to the opening. The photographic body is adapted for image capturing. The auxiliary light source, disposed between the casing and the photographic body, is adapted for emitting a light outside through the opening. The adjusting assembly, disposed in the casing, is connected to the auxiliary light source. The adjusting assembly is adapted for driving the auxiliary light source to move relative to the opening.

Another embodiment of the disclosure provides a photographic device comprising a casing, a photographic body, an auxiliary light source, a lens assembly and an adjusting assembly. The casing includes an opening. The photographic body, disposed in the casing, corresponds to the opening. The auxiliary light source, securely disposed between the casing and the photographic body, is adapted for emitting a light outside through the opening. The lens assembly, disposed at the opening, corresponds to the photographic body and the auxiliary light source, respectively. The adjusting assembly, disposed in the casing, is connected to the lens assembly. The adjusting assembly is adapted for driving the lens assembly to move relative to the opening.

### BRIEF DESCRIPTION OF THE DRAWINGS

The disclosure will become more fully understood from the detailed description given herein below for illustration only, and thus does not limit the disclosure, wherein:

FIG. 1 is a perspective view of a photographic device according to a first embodiment of the disclosure;

FIG. 2 is an exploded view of the photographic device in FIG. 1.

FIG. 3 is an exploded view of an adjusting assembly and an auxiliary light source in FIG. 1;

FIG. 4 is a top view of the auxiliary light source at a first positioning FIG. 1.

FIG. 5 is a top view of the auxiliary light source at a second positioning FIG. 1.

FIG. 6 is a perspective view of a photographic device according to a second embodiment of the disclosure; and

FIG. 7 is an exploded view of the photographic device in FIG. 6.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A photographic device provided by an embodiment of the disclosure may change the illuminating region of light emitted by an auxiliary light source according to being adjusting the distance between the auxiliary light source and an opening of a casing by an adjusting assembly, which improves the illumination and imaging effect of the photographic device.

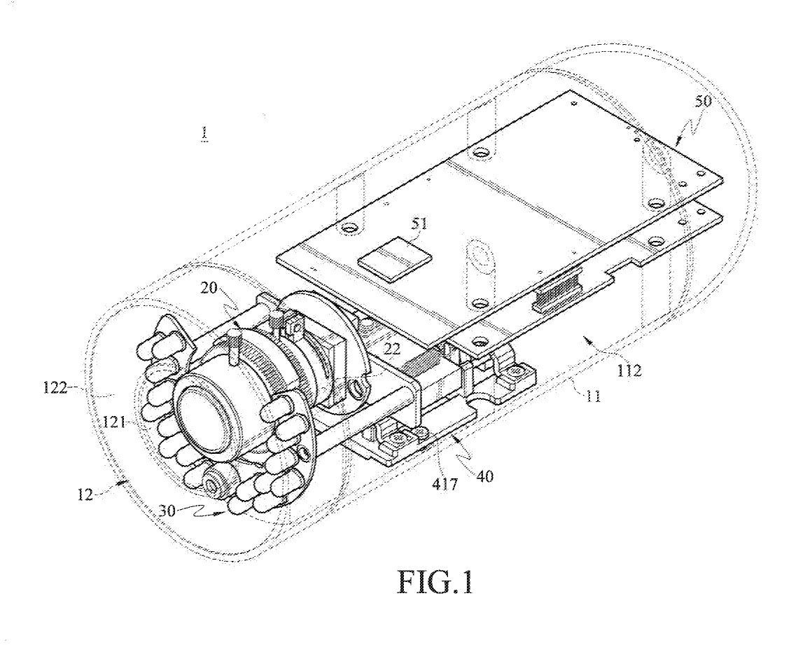

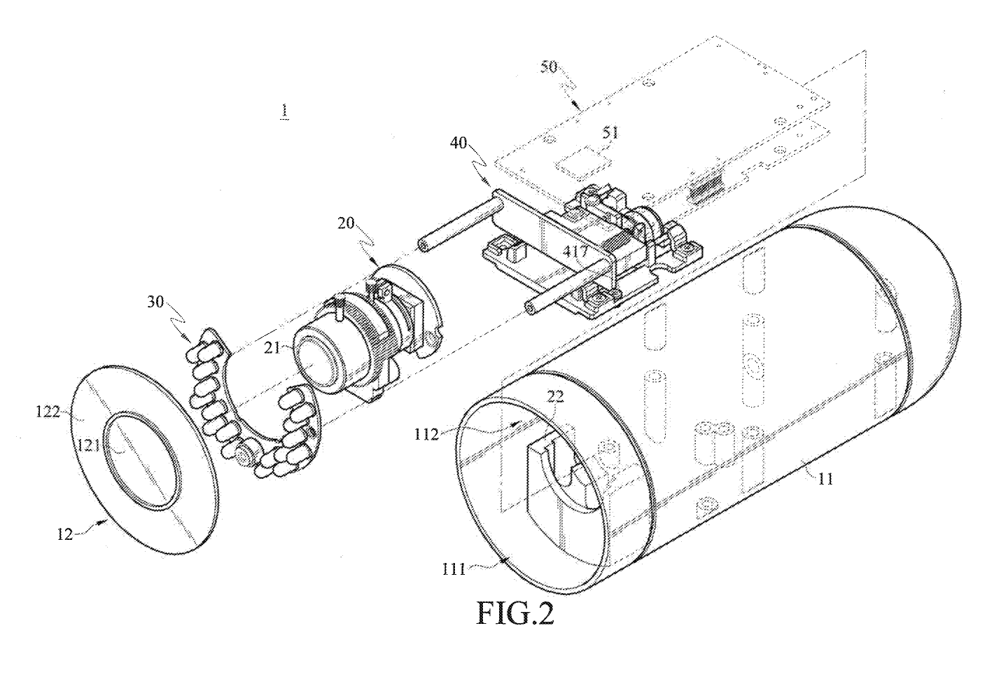

Please refer to FIGS. 1 and 2. FIG. 1 is a perspective view of a photographic device according to a first embodiment of the disclosure, and FIG. 2 is an exploded view of the photographic device in FIG. 1.

A photographic device 1, disclosed in this embodiment, is a network camera applicable to a security monitoring system, but such a photographic device 1 is not limited to the disclosure.

In this embodiment, the photographic device 1 comprises a casing 11, a photographic body 20, an auxiliary light source 30 and an adjusting assembly 40.

The casing 11 includes an opening 111 and an accommodating room 112. The opening 111 is located at an end of the casing 11. In this embodiment, the shape of the casing 11 is circular cylinder, but not limited to the disclosure. The photographic body 20, disposed in the accommodating room 112 of the casing 11, corresponds to the opening 111. The photographic body 20 is adapted for capturing an image outside through the opening 111. The auxiliary light source 30, disposed between the casing 11 and the photographic body 20, surrounds the photographic body 20. The auxiliary light source 30 is adapted for emitting light (not shown) towards the opening 111 of the casing 11. The adjusting assembly 40, disposed in the casing 11, is connected to the auxiliary light source 30. The adjusting assembly 40 is adapted for driving the auxiliary light source 30 to move relative to the opening 111.

In this embodiment and some other embodiments, the photographic device 1 further comprises a circuit board 50, securely disposed in the casing 11. Furthermore, the circuit board 50 is electrically connected to the photographic body 20, the auxiliary light source 30 and the adjusting assembly 40, respectively. Moreover, a control module Si is disposed on the circuit board 50. The control module 51 is electrically connected to the photographic body 20, the auxiliary light source 30 and the adjusting assembly 40 via the circuit board 50. The control module 51 is adapted for controlling image capturing and focusing of the photographic body 20, light emitting of the auxiliary light source 30 and driving of the adjusting assembly 40.

In this embodiment and some other embodiments, the casing 11 includes a bracket 22, the photographic body 20 is securely disposed in the accommodating room 112 of the casing 11 by the bracket 22, but this disposition is not limited to the disclosure. In other embodiments, the photographic body 20 is disposed in the casing 11 by other approaches.

In this embodiment and some other embodiments, the adjusting assembly 40 is securely disposed in the accommodating room 112 of the casing 11 by a plurality of fastening components 417, but this disposition is not limited to the disclosure. In other embodiments, the adjusting assembly 40 is disposed in the casing 11 by other approaches.

In this embodiment and some other embodiments, the photographic body 20 comprises a lens module 21. The lens module 21 corresponds to the opening 1111 and is adapted for capturing an outside image through the opening 111.

In this embodiment and some other embodiments, the photographic device 1 further comprises a lens assembly 12 which is disposed at the opening 111. The lens assembly 12 comprises a first lens element 121 and a second lens element 122. The first lens element 121 corresponds to the lens module 21, and the second lens element 122 corresponds to the auxiliary light source30. The second lens element 122 is adapted for adjusting the illuminating angle of the light emitted by the auxiliary light source 30.

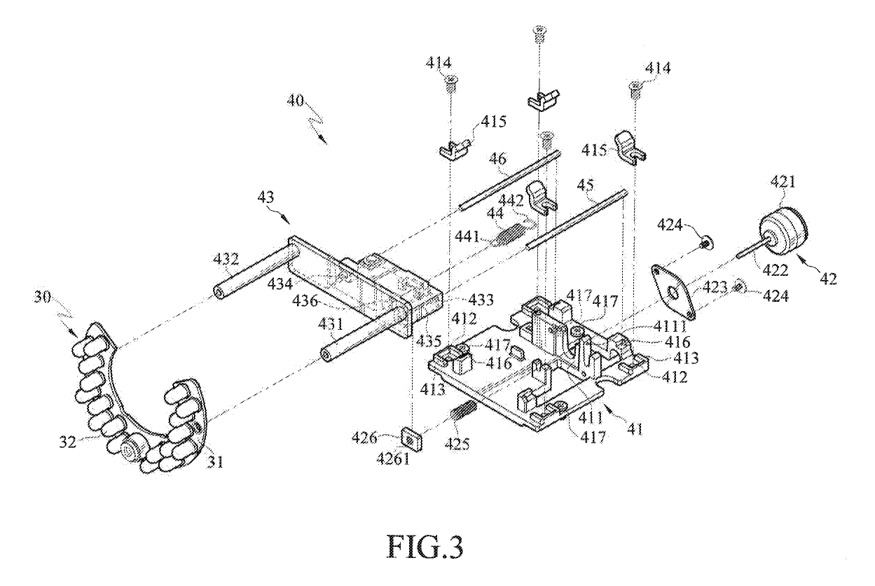

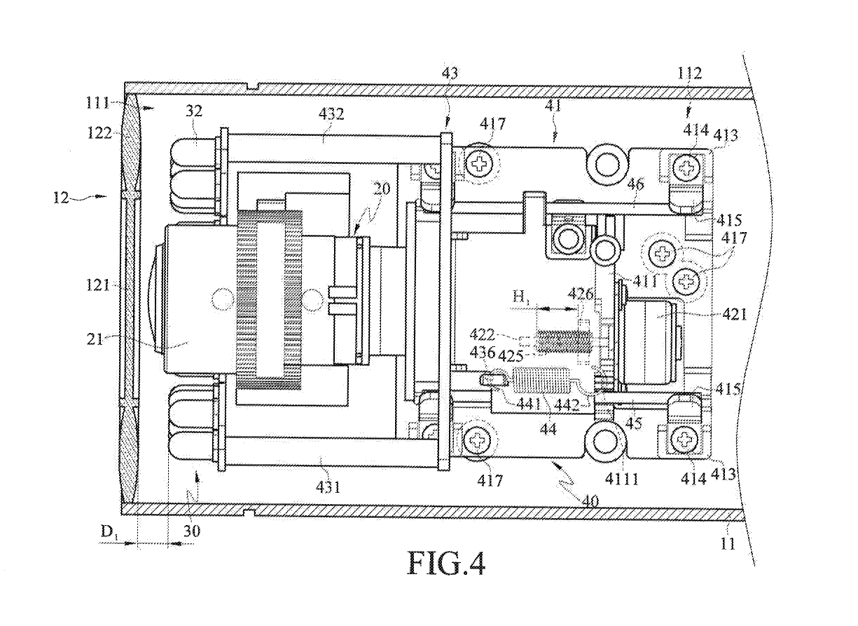

The following describes the structure of the adjusting assembly 40 and the auxiliary light source 30. Please refer to FIGS. 2 to 4, FIG. 3 is an exploded view of an adjusting assembly and an auxiliary light source in FIG. 1, and FIG. 4 is a top view of the auxiliary light source at a first positioning FIG. 1.

In this embodiment and some other embodiments, the auxiliary light source 30 comprises a fixing plate 31 and a plurality of light emitting components 32. The fixing plate 31 is connected to the adjusting assembly 40. The plurality of light emitting components 32 are disposed on the fixing plate 31, respectively, and the plurality of light emitting components 32 are adapted for emitting light towards the opening 111 of the casing 11. In this embodiment, the shape of the fixing plate 31 is spur shape, but is not limited thereto. In this embodiment, the plurality of light emitting components 32 are light emitting diodes, but are not limited thereto. The number of the plurality of light emitting components 32 is eighteen, but is not limited thereto. In other embodiments, the number of the light emitting component(s) 32 may be one or a positive integral which is more than one. In this embodiment, the light, emitted by the light emitting component 32 of the auxiliary light source 30, is visible light or infrared light.

In this embodiment and some other embodiments, the adjusting assembly 40 comprises a substrate 41, a driving assembly 42 and a connecting assembly 43. The substrate 41 is securely disposed in the casing 11. The driving assembly 42 is securely disposed on the substrate 41. One side of the connecting assembly 43 is connected to the auxiliary light source 30, and another side of the connecting assembly 43 is connected to the driving assembly 42. The driving assembly 42 is adapted for driving the connecting assembly 43 to move relative to the opening 111.

In this embodiment and some other embodiments, the substrate 41 is disposed in the casing 11 by four fastening component 417. Therefore, the adjusting assembly 40 is fastened to the casing 11.

In this embodiment and some other embodiments, the connecting assembly 43 comprises two connecting rods 431 and 432. The connecting rods 431 and 432 are connected to the fixing plate 31, respectively. When the connecting assembly 43 moves, the auxiliary light source 30 is also moved by the driven of the connecting assembly 43, such that the auxiliary light source 30 is moved synchronously with the connecting assembly 43.

The following describes the structure of the driving assembly 42, In this embodiment and some other embodiments, the driving assembly 42 comprises a motor 421, a lead screw 425 and a sliding block 426. The motor 421 is disposed on the substrate 41. The lead screw 425 is connected to the motor 421. The sliding block 426 is disposed around the lead screw 425 and is connected to the connecting assembly 43. When the control module Si controls the motor 421 to drive the lead screw 425 to rotate, the lead screw 425 drives the sliding block 426 to move linearly along the lead screw 425, such that the sliding block 426 drives the connecting assembly 43 to move relative to the opening 111.

In this embodiment and some other embodiments, the driving assembly 42 further comprises an axial rod 422, a positioning plate 423 and two fastening components 424. The substrate 41 includes a wall 411. The connecting assembly 43 includes an engaging portion 435. The motor 421 is fastened to the positioning plate 423, and the positioning plate 423 is securely disposed on the wall 411 of the substrate 41 by those two fastening components 424. Therefore, the motor 421 is affixed to the substrate 41. Next, the axial rod 422 is connected to the motor 421. Therefore, the lead screw 425 is connected to the motor 421 by the axial rod 422. Moreover, the lead screw 425 penetrates through the sliding block 426. The sliding block 426 includes threads 4261 corresponding to the lead screw 425. The sliding block 426 is connected to the engaging portion 435 of the connecting assembly 43. Therefore, when the motor 421 drives the sliding block 426 to move, the sliding block 426 drives the connecting assembly 43 to move relative to the opening 111 at the same time.

The following describes the disposition structure of the connecting assembly 43. In this embodiment and some other embodiments, the adjusting assembly 40 further comprises a first guiding rod 45 and a second guiding rod 46. The connecting assembly 43 includes a first groove 433 and a second groove 434. The first guiding rod 45 penetrates through the first groove 433 of the connecting assembly 43, and therefore the first guiding rod 45 is securely disposed on the substrate 41. The second guiding rod 46 penetrates through the second groove 434 of the connecting assembly 43, and therefore the second guiding rod 46 is securely disposed on the substrate 41. The connecting assembly 43 is moved relative to the first guiding rod 45 and the second guiding rod 46 through the first groove 433 and the second groove 434.

In this embodiment and some other embodiments, the substrate 41 further includes four third through holes 412, four positioning portions 413 and four leaning portions 416. The adjusting assembly 40 further comprises four fastening components 414 and four positioning elements 415. On one side of the substrate 41, the two ends of the first guiding rod 45 are disposed on the substrate 41 through the two corresponding leaning portions 416, respectively. The two positioning elements 415 are pressed against the two ends of the first guiding rods 45, respectively. Moreover, the two positioning elements 415 are affixed to the substrate 41 by the two fastening component 414. Also, the leaning portion 416 is used for preventing the two positioning element 415 from pivoting relative to the third through hole 412. On another side of the substrate 41, the two ends of the second guiding rod 46 are disposed on the substrate 41 through the other two leaning portions 416, respectively. The other two positioning elements 415 are pressed against the two ends of the second guiding rod 46, respectively. Next, the other two positioning elements 415 are disposed on the substrate 41 by the other two fastening components 414, respectively. Also, the other two leaning portions 416 prevent the other two positioning elements 415 from pivoting relative to the third through hole 412. By means of the above-mentioned disposition, the connecting assembly 43 is removably disposed on the substrate 41 through the first guiding rod 45 and the second guiding rod 46. In other words, when the driving assembly 42 drives the connecting assembly 43, the connecting assembly 43 is moved relative to the first guiding rod 45 and the second guiding rod 46.

In this embodiment and some other embodiments, the adjusting assembly 40 further comprises an elastic component 44. The connecting assembly 43 includes a first through hole 436. The wall 411 of the substrate 41 includes a second through hole 4111. The elastic component 44 includes a first end 441 and a second end 442 opposite to each other. The first end 441 of the elastic component 44 is connected to the first through hole 436 of the connecting assembly 43. Also, the second end 442 of the elastic component 44 is connected to the second through hole 4111 of the substrate 41. In this embodiment, the elastic component 44 is a spring, but is not limited thereto.

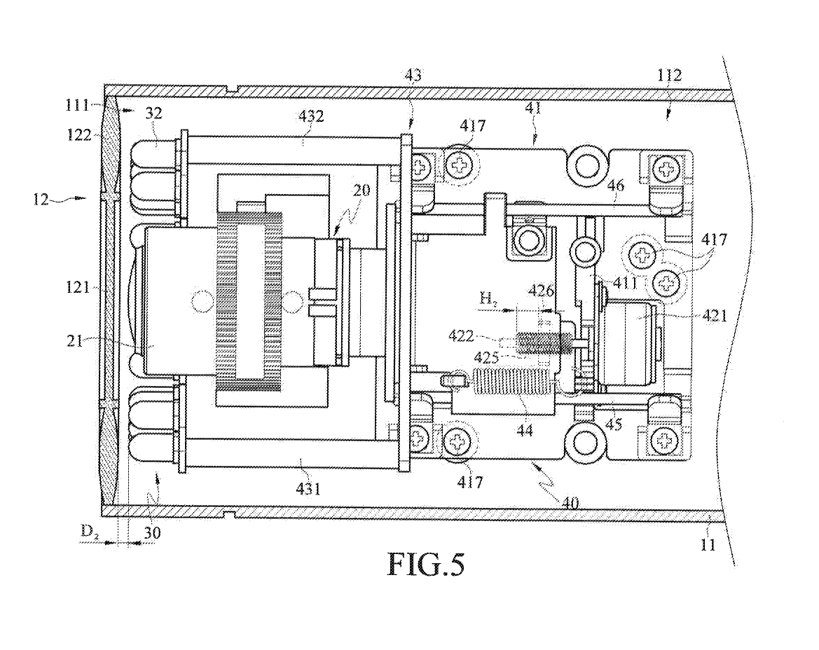

The following describes the moving of the auxiliary light source 30. Please refer to FIGS. 4 and 5, and FIG. 5 is a top view of the auxiliary light source at a second positioning FIG. 1. In this embodiment and some other embodiments, the auxiliary light source 30 includes a first position (as shown in FIG. 4) and a second position (FIG. 5). When the auxiliary light source 30 is at the first position, the light emitting component 32 and the second lens element 122 located at the opening 111 are separated by a first distance DI. The sliding block 426 and an end of the lead screw 425 are separated by a first length H1. Next, when the motor 421 operates and rotates, the axial rod 422 rotates according to the motor 421. Meanwhile, the lead screw 425 on the axial rod 422 rotates according to the axial rod 422. Next, the lead screw 425 drives the sliding block 426 to move linearly towards the opening 111. When the sliding block 426 moves, the connecting assembly 43 and the auxiliary light source 30 moves towards the opening 111 accordingly. Then, the light emitting components 32 and the second lens element 122 located at the opening 111 are separated by a second distance D2. The sliding block 426 and an end of the lead screw 425 are separated by a second length H2. The second distance D2 is less than the first distance D1, and the second length H2 is less than the first length H1. Therefore, according to the above description, the adjusting assembly 40 drives the auxiliary light source 30 to move, so as to automatically adjust the illuminating angle of light emitted by the auxiliary light source 30, thereby achieving a better image capturing effect. That is to say, when the photographic device 1 needs to change its field of view (imaging region), the photographic body 20 automatically adjusts the lens module 21, and the adjusting assembly 40 drives the auxiliary light source 30 to change the illuminating angle of the auxiliary light source 30, thereby obtaining appropriate illuminating region and illumination (lux).

In this embodiment and some other embodiments, a user may operate control module 51 through a user command (namely, to operate manually) to drive the adjusting assembly 40, which drives the auxiliary light source 30 to move, thereby changing the illuminating angle and the illuminating region of the light. However, the above-mentioned manual operation is not limited thereto. In other embodiments, the user may remotely observe the image or video captured or recorded by the photographic body 20, so as to operate the control module 51 immediately to drive the adjusting assembly 40. Therefore, the position of the auxiliary light source 30 is adjusted. Moreover, the photographic device 1 may also adjust the auxiliary light source 30 automatically. In other embodiments, the control module 51 is configured to automatically adjust the position of the auxiliary light source 30 according to a programmable setting. In other embodiments, the control module 51 is configured to automatically adjust the position of the auxiliary light source 30 according to the change in the field of view of the photographic body 20.

The following describes the structure of a photographic device in another embodiment. According to a photographic device in another embodiment of the disclosure, by means of the adjusting assembly being adjusting the distance between the lens assembly and the opening, the illuminating region of an auxiliary light source is adjusted, thereby improving the illumination and the imaging effect of the photographic device.

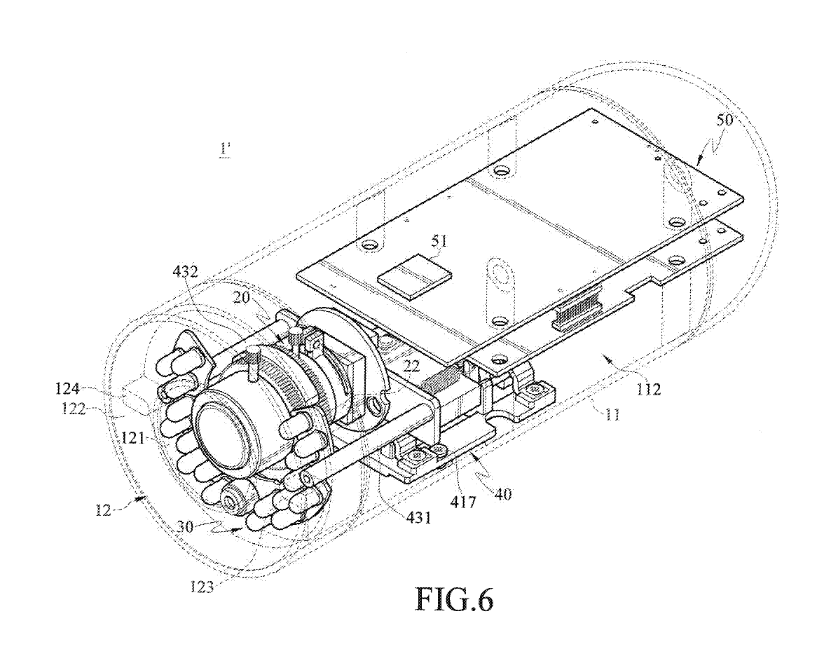

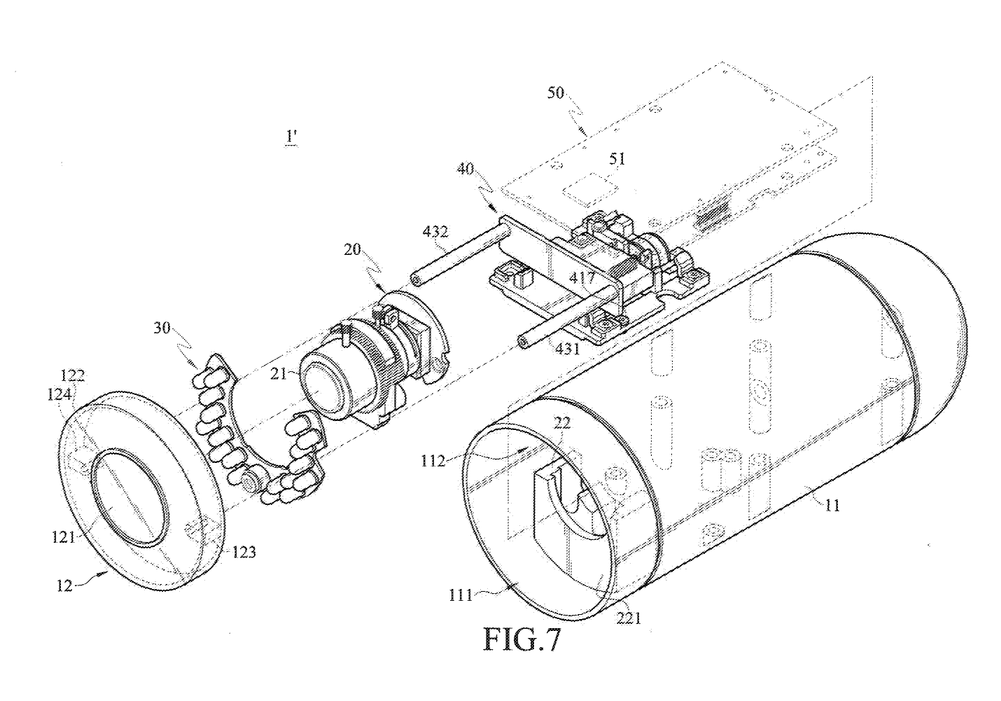

Please refer to FIGS. 6 and 7, FIG. 6 is a perspective view of a photographic device according to a second embodiment of the disclosure, and FIG. 7 is an exploded view of the photographic device in FIG. 6. The structure in this embodiment is similar to that in the first embodiment, and therefore the same numerals represent similar structure. In this embodiment, a photographic device 1′ comprises the casing 11, the photographic body 20, the auxiliary light source 30, the lens assembly 12 and the adjusting assembly 40. Compared to the first embodiment, the auxiliary light source 30 in this embodiment is securely disposed on a surface 221 of the bracket 22, but this disposition is not limited thereto. In other embodiments, the auxiliary light source 30 is securely disposed on the photographic body 20.

In this embodiment, the adjusting assembly 40 comprises a substrate 41, a driving assembly 42 and a connecting assembly 43. The structure of the adjusting assembly 40 is similar to that in the first embodiment, and therefore the similar is not repeated herein. The lens assembly 12 further comprises two fastening portions 123 and 124. The connecting rod 431 of the connecting assembly 43 is connected to the fastening portion 123, and the connecting rod 432 of the connecting assembly 43 is connected to the fastening portion 124. Compared to the first embodiment, the connecting rods 431 and 432 are not interfered with the fixing plate 31. Thus, when the field of view of the photographic body 20 of the photographic device 1′ needs to be changed, the adjusting assembly 40 automatically adjusts the distance between the lens assembly 12 and the opening 111. That is to say, the driving assembly 42 drives the connecting rods 431 and 432 of the connecting assembly 43 to move the lens assembly 12. Meanwhile, the auxiliary light source 30 emits light. Because the distance between the lens assembly 12 and the auxiliary light source 30 is adjusted by the adjusting assembly 40, the light emitted by the auxiliary light source30 is diverged through the lens assembly 12, and the illuminating region and the illuminating angle of the light are varied according to the changed distance between the lens assembly 12 and the auxiliary light source 30, thereby conforming to the field of view of the requirements of the photographic body 20. By the above-mentioned structure and the work of the adjusting assembly 40, the illumination and the imaging effect of the photographic device 1′ are enhanced.

Based on the first embodiment, the adjusting assembly automatically adjusts the distance between the auxiliary light source and the opening according to the changing of the field of view of the photographic body, thereby solving the problems of uneasy installation and inconvenient adjustment of the auxiliary light source. Moreover, the photographic device in this embodiment may adjust the distance between the auxiliary light source and the opening remotely or automatically, so as to adjust the illuminating region and the illuminating angle of the light emitted by the auxiliary light source, thereby improving the illumination and imaging effects of the photographic device. Furthermore, according to another embodiment of the disclosure, the illuminating region and the illuminating angle of the light emitted by the auxiliary light source are adjusted when the adjusting assembly automatically adjusts the distance between the lens assembly and the auxiliary light source, the illuminating region and the illuminating angle of the light emitted by the auxiliary light source are adjusted accordingly, thereby improving the illumination and imaging effects of the photographic device as well.

In addition to the above-mentioned integrated structure, the concept of the disclosure is further applicable for an independent lighting device which forms a system with a photographic device. An adjusting assembly, such as the above-mentioned structure, is controlled via a transmission interface (such as Ethernet), such that the linked and interconnected effects of the independent lighting device and the photographic device are achieved as well.

What is claimed is:

1. A photographic device, comprising:
a casing, and the casing including an opening;
a photographic body disposed in the casing, and the photographic body corresponding to the opening, and the photographic body being adapted for image capturing;
an auxiliary light source disposed between the casing and the photographic body, and the auxiliary light source being adapted for emitting light outside through the opening; and
an adjusting assembly disposed in the casing and connected to the auxiliary light source, and the adjusting assembly being adapted for driving the auxiliary light source to move relative to the opening.

2. The photographic device according to claim 1, further comprising:
a lens assembly disposed at the opening, the lens assembly including a first lens element and a second lens element, the first lens element being corresponding to the photographic body, and the second lens element being corresponding to the auxiliary light source.

3. The photographic device according to claim 1, wherein the adjusting assembly comprising:
a substrate securely disposed in the casing;
a driving assembly securely disposed on the substrate; and
a connecting assembly, and two sides of the connecting assembly being connected to the auxiliary light source and the driving assembly, respectively;
wherein the driving assembly being adapted for driving the connecting assembly to move relative to the opening.

4. The photographic device according to claim 3, wherein the driving assembly comprising:
a motor disposed on the substrate;
a lead screw connected to the motor, and the motor being adapted for driving the lead screw to rotate; and
a sliding block disposed around the lead screw and engaged with the connecting assembly;
wherein, when the motor drives the lead screw to rotate, the lead screw drives the sliding block to move linearly along the lead screw, such that the sliding block drives the connecting assembly to move relative to the opening.

5. The photographic device according to claim 3, wherein the adjusting assembly further comprises:
an elastic component, one end of the elastic component being connected to the substrate, and the other end of the elastic component being connected to the connecting assembly.

6. The photographic device according to claim 3, wherein the adjusting assembly further comprises a first guiding rod and a second guiding rod, the connecting assembly includes a first groove and a second groove, the first guiding rod is securely disposed on the substrate and penetrates the first groove, the second guiding rod is securely disposed on the substrate and penetrates the second groove, and the connecting assembly is adapted for moving relative to the first guiding rod and the second guiding rod.

7. The photographic device according to claim 1, wherein the auxiliary light source comprises:
a fixing plate connected to the adjusting assembly; and
at least one light emitting component disposed on the fixing plate, the at least one light emitting component is adapted for emitting the light outside through the opening.

8. The photographic device according to claim 1, further comprising:
a control module, disposed in the casing, the control module being electrically connected to the photographic body, the auxiliary light source and the adjusting assembly, respectively, the control module being configured to control the imaging capturing and focusing of the photographic body, light emitting of the auxiliary light source and driving of the adjusting assembly.

9. A photographic device, comprising:
a casing, and the casing including an opening;
a photographic body disposed in the casing, and the photographic body being corresponding to the opening;
an auxiliary light source securely disposed between the casing and the photographic body, and the auxiliary light source being adapted for emitting light outside through the opening;
a lens assembly disposed at the opening, the lens assembly being corresponding to the photographic body and the auxiliary light source, respectively; and
an adjusting assembly disposed in the casing and connected to the lens assembly, and the adjusting assembly being adapted for driving the lens assembly to move relative to the opening.

10. The photographic device according to claim 9, wherein the adjusting assembly comprises:
a substrate securely disposed in the casing;
a driving assembly securely disposed on the substrate; and
a connecting assembly, and two sides of the connecting assembly being connected to the lens assembly and the driving assembly, respectively;
wherein the driving assembly is adapted for driving the connecting assembly relative to the opening.

11. The photographic device according to claim 10, wherein the driving assembly comprises:
a motor disposed on the substrate;
a lead screw connected to the motor, and the motor being adapted for driving the lead screw to rotate; and
a sliding block disposed around the lead screw and engaged with the connecting assembly;
wherein, when the motor drives the lead screw to rotate, the lead screw drives the sliding block to move linearly along the lead screw, such that the sliding block drives the connecting assembly to move relative to the opening.

12. The photographic device according to claim 10, wherein the adjusting assembly further comprises:
an elastic component, one end of the elastic component being connected to the substrate, and the other end of the elastic component being connected to the connecting assembly.

13. The photographic device according to claim 10, wherein the adjusting assembly further comprises a first guiding rod and a second guiding rod, the connecting assembly includes a first groove and a second groove, the first guiding rod is securely disposed on the substrate and penetrates through the first groove, the second guiding rod is securely disposed on the substrate and penetrates through the second groove, and the connecting assembly is adapted for moving relative to the first guiding rod and the second guiding rod.

14. The photographic device according to claim 10, wherein the lens assembly comprises at least one fastening portion, and the at least one fastening portion is connected to the connecting assembly.

15. The photographic device according to claim 9, further comprising:
a control module disposed in the casing, the control module is electrically connected to the photographic body, the auxiliary light source and the adjusting assembly, the control module is adapted for controlling capturing and focusing of the photographic body, light emitting of the auxiliary light source and driving of the adjusting assembly.
